(19) United States
(12) Patent Application Publication
(10) Pub. No.: US 2023/0360261 A1
(43) Pub. Date: Nov. 9, 2023

(54) POSTURE ESTIMATION SYSTEM

(71) Applicants: JOHNAN Corporation, Uji-shi, Kyoto (JP); tiwaki Co., Ltd., Kusatsu-city, Shiga (JP)

(72) Inventors: Kozo MORIYAMA, Uji-shi (JP); Shin KAMEYAMA, Uji-shi (JP); Xiang RUAN, Kusatsu-city (JP); Tomohiro NAKAGAWA, Kusatsu-city (JP); Taro WATASUE, Kusatsu-city (JP)

(73) Assignees: JOHNAN Corporation, Uji-shi, Kyoto (JP); tiwaki Co., Ltd., Kusatsu-city, Shiga (JP)

(21) Appl. No.: 18/026,352

(22) PCT Filed: Mar. 18, 2022
(86) PCT No.: PCT/JP2022/012495

§ 371 Date: Mar. 15, 2023

(30) Foreign Application Priority Data
Mar. 31, 2021 (JP) 2021-059267

(51) Int. Cl. G06T 7/73; G06T 7/55

(52) U.S. Cl. CPC G06T 7/74; G06T 7/55; G06T 2207/20081; G06T 2207/10028; G06T 2207/10024; G06T 2207/30196

(57) ABSTRACT

A posture estimation system for estimating a posture of an object is provided, which includes: a plurality of three-dimensional cameras taking images of the object from different angles; an estimation section estimating, by using two-dimensional images respectively acquired by the plurality of three-dimensional cameras, a position of a predetermined section of the object on the two-dimensional images; a determination section determining reliability of depth information on the position estimated by the estimation section based on a change over time of the depth information; and a calculation section calculating the position of the predetermined section of the object in consideration of a determination result of the determination section.

### TECHNICAL FIELD

The present invention relates to a posture estimation system.

### BACKGROUND ART

Conventionally, a posture estimation device for estimating a posture of a person is known (for example, see Patent Document 1).

A posture estimation device disclosed in Patent Document 1 is configured to estimate positions of respective sections of a human body using a three-dimensional sensor capable of measuring a position of the human in the real space.

### PRIOR ART DOCUMENT

### Patent Document

[Patent Document 1] JP 2017-068424 A

### SUMMARY OF THE INVENTION

### Problem to Be Solved by the Invention

In the case where a position of a section of a person is estimated using the three-dimensional sensor as described above, if the section of the person is hidden behind an obstacle or the like, it becomes difficult to estimate the position of the section. For example, when an image of a person is taken by an RGB-D camera to estimate a position (two-dimensional position) of a section of the person on the RGB image and to calculate the position (three-dimensional position) of the section of the person using depth information on the estimated position, if the section of the person is hidden behind an obstacle or the like, the depth information on the estimated position of the section of the person on the RGB image corresponds to the position of the obstacle. Thus, it is difficult to calculate the position of the hidden section. Here, there is still a room for improvement of accuracy in the posture estimation.

The present invention was made in consideration of the above problems, an object of which is to provide a posture estimation system capable of improving accuracy in the posture estimation.

### MEANS FOR SOLVING THE PROBLEM

A posture estimation system for estimating a posture of an object in the present invention includes: a plurality of three-dimensional cameras taking images of the object from different angles; an estimation section estimating, by using two-dimensional images respectively acquired by the plurality of three-dimensional cameras, a position of a predetermined section of the object on the two-dimensional images; a determination section determining reliability of depth information on the position estimated by the estimation section based on a change over time of the depth information; and a calculation section calculating the position of the predetermined section of the object in consideration of a determination result of the determination section.

With the above-described configuration, it is possible to improve accuracy in the posture estimation by calculating the position of the predetermined section of the object in consideration of the reliability of the depth information by the plurality of three-dimensional cameras.

In the above-described posture estimation system, the estimation section may learn a feature of the predetermined section of the object on the two-dimensional images so as to track the predetermined section.

A posture estimation system for estimating a posture of an object in the present invention includes: at least three three-dimensional cameras taking images of the object from different angles; a three-dimensional position calculation section calculating three-dimensional positions of a predetermined section of the object based on respective three-dimensional images acquired by the at least three three-dimensional cameras; and a reliability evaluation section evaluating reliability of each of the three-dimensional positions based on at least three of the three-dimensional positions calculated by the three-dimensional position calculation section.

The posture estimation system as described above may further include an estimation section estimating, by using respective two-dimensional images by the at least three three-dimensional cameras, a position of the predetermined section of the object on the two-dimensional images. The estimation section may learn a feature of the predetermined section of the object on the two-dimensional images so as to track the predetermined section, and furthermore may re-learn the feature of the predetermined section on a two-dimensional image by a three-dimensional camera whose acquired three-dimensional position is estimated to have a low reliability by the reliability evaluation section out of the at least three three-dimensional cameras, so as to re-track the predetermined section.

### EFFECTS OF THE INVENTION

With the posture estimation system of the present invention, it is possible to improve accuracy in the posture estimation.

### BRIEF DESCRIPTION OF THE DRAWINGS

FIG. 1 is a block diagram illustrating a schematic configuration of a posture estimation system according to an embodiment.

FIG. 2 is a flowchart indicating operations of the posture estimation system according to the embodiment.

### MODE FOR CARRYING OUT THE INVENTION

Hereinafter, an embodiment of the present invention will be described.

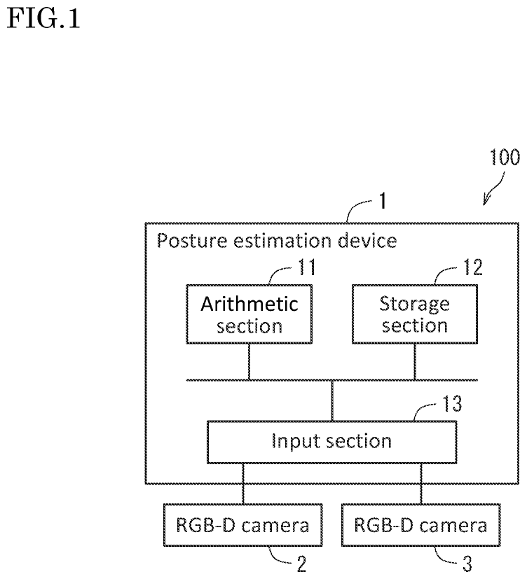

A description is given on a configuration of a posture estimation system 100 according to an embodiment of the present invention with reference to FIG. 1.

The posture estimation system 100 is configured, for example, to calculate positions of respective sections of the skeleton of a person so as to estimate a posture of the person. Examples of the sections of the skeleton of a person include joints such as a shoulder joint, an elbow joint and a wrist. However, the sections of the skeleton are not limited thereto. In the present invention, a person is an example of the “object”. As shown in FIG. 1, the posture estimation system 100 includes: a posture estimation device 1; and RGB-D cameras 2 and 3.

The RGB-D cameras 2 and 3 take images of a person positioned in a predetermined measurement area so as to acquire RGB-D images. The RGB-D image includes an RGB image (color image) and a depth image, and has depth information on each pixel on the RGB image. The RGB-D cameras 2 and 3 are each an example of the “three-dimensional camera” of the present invention, and the RGB image is an example of the “two-dimensional image” of the present invention.

The RGB-D cameras 2 and 3 are provided to take images of a person from different angles. In this way, even when a predetermined section of the person is hidden behind an obstacle or the like on one RGB image taken by one of the RGB-D cameras 2 and 3, this predetermined section is likely to appear on another RGB image taken by the other of the RGB-D cameras 2 and 3. Thus, the two RGB-D cameras 2 and 3 are provided to prevent the section(s) of the person positioned in the predetermined measurement area from being in the blind spot.

The posture estimation device 1 is configured to estimate the posture of the person using the RGB-D images that are input from the RGB-D cameras 2 and 3. The posture estimation device 1 stores, in advance, information on the positions and the postures of the RGB-D cameras 2 and 3 (external parameters) so as to merge data by adopting more reliable data out of the data by the RGB-D image from the RGB-D camera 2 and the data by the RGB-D image from the RGB-D camera 3. Thus, it is possible to improve accuracy in the posture estimation.

More specifically, the posture estimation device 1 estimates the positions of the respective sections of the person on the RGB image using the RGB image by the RGB-D camera 2. Also, the posture estimation device 1 estimates the positions of the respective sections of the person on the RGB image using the RGB image by the RGB-D camera 3. That is, the positions of the respective sections on the two-dimensional RGB image by the RGB-D camera 2 are estimated while the positions of the respective sections on the two-dimensional RGB image by the RGB-D camera 3 are estimated.

Also, the posture estimation device 1 learns features of the sections of the person on the RGB images by the RGB-D cameras 2 and 3 so as to track the sections. That is, a section of the person is extracted by image processing and the extracted section (image feature) is tracked. Furthermore, when a section of the person is hidden behind an obstacle or the like, the posture estimation device 1 estimates the position (two-dimensional position) of the hidden section using, for example, well-known algorithm. However, the depth information on the section hidden behind the obstacle does not indicate the depth of the section itself, but the depth of the obstacle. Therefore, when the depth information on the section hidden behind the obstacle is used, the accuracy in the estimation of the position (three-dimensional position) of the section may be degraded. Thus, in this embodiment, the reliability of the depth information is estimated so as to calculate the position of the section taking into account the reliability.

The posture estimation device 1 determines the reliability of the depth information on the position of the section of the person estimated on the RGB image from the RGB-D camera 2 based on the change over time of the depth information. Also, the posture estimation device 1 determines the reliability of the depth information on the position of the section of the person estimated on the RGB image from the RGB-D camera 3 based on the change over time of the depth information. That is, the reliability of the depth information on the section on the RGB image that is input from the RGB-D camera 2 is determined while the reliability of the depth information on the section on the RGB image that is input from the RGB-D camera 3 is determined. The change over time of the depth information is a change of the depth information, for example, for the period of time from a predetermined previous time point to the current time point.

For example, when the predetermined section of the person is not hidden, the depth information on the predetermined section gradually (linearly) changes in association with the movement (change in the posture) of the person. On the other hand, when the predetermined section of the person is hidden, the depth information is shifted from that on the predetermined section to that on the obstacle, which results in a sudden change in the depth information (specifically, the distance from the camera is suddenly shortened). Therefore, the posture estimation device 1 determines that the reliability of the depth information on the section of the person is higher, for example, as the change over time of the depth information on the section of the person estimated on the RGB image is smaller.

Thus, the posture estimation device 1 calculates the position (three-dimensional position) of the section of the person using the depth information having a higher reliability out of the RGB-D images from the RGB-D cameras 2 and 3. That is, regarding respective sections of the person, the position (three-dimensional position) of the section is calculated using an input having the higher reliability out of the inputs from the RGB-D cameras 2 and 3. More specifically, in the case where the input of the left shoulder of the person from the RGB-D camera 2 has a higher reliability, the position of the left shoulder is calculated using the RGB-D image from the RGB-D camera 2, while the input of the right shoulder of the person from the RGB-D camera 3 has a higher reliability, the position of the right shoulder is calculated using the RGB-D image from the RGB-D camera 3.

Also, the posture estimation device 1 includes: an arithmetic section 11; a storage section 12; and an input section 13. The arithmetic section 11 controls the posture estimation device 1 by executing arithmetic processing based on programs and the like stored in the storage section 12. The storage section 12 stores: the programs to estimate the posture of a person; the positions and the postures of the RGB-D cameras 2 and 3; and the like. The input section 13 is connected to the RGB-D cameras 2 and 3 so that the image results (RGB-D images) taken by the RGB-D cameras 2 and 3 are input to the input section 13. The “estimation section”, the “determination section” and the “calculation section” of the present invention are realized by executing, by the arithmetic section 11, the programs stored in the storage section 12.

### Operations of Posture Estimation System

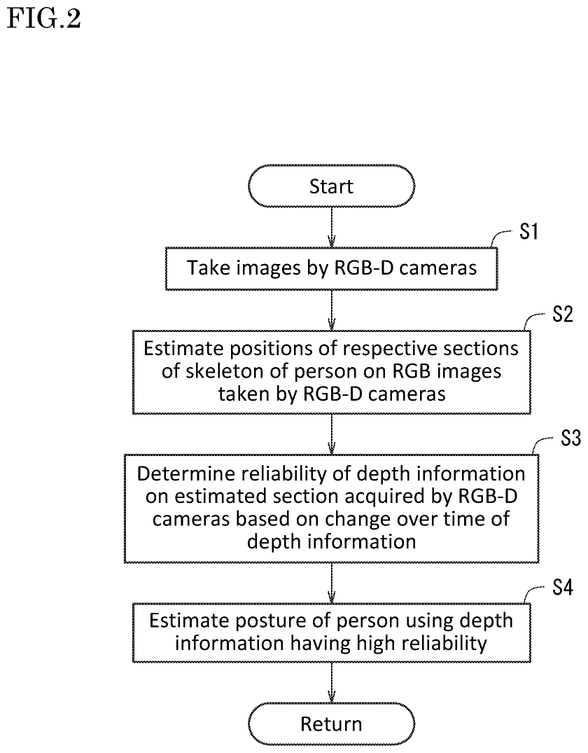

Here, operations of the posture estimation system 100 (i.e. posture estimation method) according to this embodiment will be described referring to FIG. 2. Before starting the operations of the posture estimation, the respective sections of the person positioned in the measurement area (i.e. all the sections of the measurement object) are set so as to be exposed to the RGB-D cameras 2 and 3. Thus, initial positions (positions at the time of starting the operation) of the respective sections are accurately calculated. In this way, the features of the respective sections of the person on the RGB images of the RGB-D cameras 2 and 3 are learned so as to track the respective sections. The workflow below is repeatedly performed from the start of the posture estimation operation to the termination thereof.

First, in step S1 in FIG. 2, the RGB-D cameras 2 and 3 take images of a person positioned in the measurement area. Then, the RGB-D images acquired by the RGB-D cameras 2 and 3 are transmitted from the RGB-D cameras 2 and 3 to the posture estimation device 1.

Next, in step S2, the posture estimation device 1 estimates the positions of the respective sections of the person on the RGB image from the RGB-D camera 2 and the positions of the respective sections of the person on the RGB image from the RGB-D camera 3. For example, the positions of the respective sections of the person are estimated by tracking the learned respective sections of the person on the RGB images.

Next, in step S3, the posture estimation device 1 determines the reliability of the depth information on the position of the section of the person estimated on the RGB image from the RGB-D camera 2 based on the change over time of the depth information. This determination of the reliability is performed with respect to the respective sections of the person estimated on the RGB image from the RGB-D camera 2. Also, the posture estimation device 1 determines the reliability of the depth information on the position of the section of the person estimated on the RGB image from the RGB-D camera 3 based on the change over time of the depth information. This determination of the reliability is performed with respect to the respective sections of the person estimated on the RGB image from the RGB-D camera 3.

Next, in step S4, the posture estimation device 1 calculates the position (three-dimensional position) of the section of the person using the depth information having a higher reliability. Specifically, the position of the section of the person is calculated based on the RGB-D image by the camera that obtains higher reliable depth information. This calculation of the position is performed with respect to the respective sections of the person so as to estimate the posture of the person.

### Effects

In this embodiment having the RGB-D cameras 2 and 3 as described above, the positions of the respective sections of the person are calculated taking into account the reliability of the depth information from the RGB-D cameras 2 and 3, which contributes to improvement of accuracy in the posture estimation. That is, it is possible to improve accuracy in the posture estimation by not using the depth information having a lower reliability caused by the section of the person hidden behind the obstacle or the like.

Also in this embodiment, even when a predetermined section of the person is out of the angle of view of either one of the RGB-D cameras 2 and 3, it is possible to appropriately perform the posture estimation if the predetermined section is in the angle of view of the other of the RGB-D cameras 2 and 3.

Also in this embodiment, it is possible to improve accuracy in the estimation of the positions of the respective sections on the RGB image by learning the features of the respective sections of the person on the RGB images.

### Other Embodiments

The foregoing embodiment is to be considered in all respects as illustrative and not limiting. The scope of the invention is indicated by the appended claims rather than by the foregoing description, and all modifications and changes that come within the meaning and range of equivalency of the claims are intended to be embraced therein.

For example, in the above-described embodiment, the posture of a person is exemplarily estimated. However, the present invention is not limited thereto. The posture of an object other than the person may also be estimated.

Also in the above-described embodiment, two RGB-D cameras 2 and 3 are exemplarily provided. However, the present invention is not limited thereto. Three or more numbers of RGB-D cameras may be provided. In this case, the posture estimation device may calculate the three-dimensional positions of the predetermined section of the person based on respective RGB-D images (three-dimensional images) by the three or more RGB-D cameras, and also may evaluate the reliability of the respective three-dimensional positions using the three or more calculated three-dimensional positions. For example, in the case where three RGB-D cameras are provided, when the three-dimensional positions of the predetermined section based on the RGB-D images from two RGB-D cameras are the same while the three-dimensional position of the predetermined section based on the RGB-D image from the remaining one RGB-D camera is different from the above matched three-dimensional position, it is evaluated that the reliability of the three-dimensional position by the two RGB-D cameras is high and that the reliability of the three-dimensional position by the remaining one RGB-D camera is low. That is, it is evaluated whether the respective RGB-D cameras appropriately capture the predetermined section based on the respective three-dimensional positions of the RGB-D images from the three RGB-D cameras. In this case, the three-dimensional positions of the two RGB-D cameras are the same because the two RGB-D cameras appropriately capture the predetermined section, while the three-dimensional position of the remaining one RGB-D camera is different from the above matched three-dimensional position because this one RGB-D camera does not appropriately capture the predetermined section. Thus, the matched three-dimensional position by the two RGB-D cameras having a high reliability is adopted as the position of the predetermined section of the person. With this configuration also, it is possible to improve accuracy in the posture estimation. In addition, the posture estimation device may further determine the reliability based on the change over time of the depth information. That is, the posture estimation device may estimate the position of the predetermined section of the person on the RGB image using the RGB images by the RGB-D cameras while determining the reliability of the depth information on the predetermined section from the RGB-D cameras based on the change over time of the depth information on the estimated position of the predetermined section. Also, the posture estimation device may learn the feature of the predetermined section of the person on the RGB images taken by the RGB-D cameras so as to track the predetermined section and furthermore may re-learn the feature of the predetermined section on the two-dimensional image taken by the RGB-D camera whose acquired three-dimensional position is evaluated to have a low reliability (i.e. by the remaining one RGB-D camera in the above-described case) so as to re-track the predetermined section. In other words, the posture estimation device re-learns the predetermined section not appropriately captured by the RGB-D camera so as to re-track the predetermined section. In the posture estimation device, the “estimation section”, the “determination section”, the “calculation section”, the “three-dimensional position calculation section” and the “reliability evaluation section” of the present invention are realized by executing, by the arithmetic section, the programs stored in the storage section.

Also in the above-described embodiment, the case is exemplarily described, in which the reliability is determined to be high as the change over time of the depth information is small. However, the present invention is not limited thereto. The reliability may be determined to be high when the change over time of the depth information is within a predetermined range, and may be determined to be low when the change over time of the depth information is out of the predetermined range.

Also in the above-described embodiment, the reliability of the depth information may be determined in consideration of other factors in addition to the change over time. For example, the reliability may be determined to be high as the distance between the predetermined section and a section closest to the predetermined section is large. Also, the reliability may be determined to be high when the image quality of the circumference of the predetermined section on the RGB image is high (i.e. when the image is not blurred and has a sharp contrast). Also, the reliability may be determined to be high when the distance from the camera to the predetermined section is close.

Also in the above-described embodiment, when the reliability of the depth information on the predetermined section by both the RGB-D cameras 2 and 3 is low, the report that the predetermined section is unmeasurable may be output.

Also in the RGB-D cameras 2 and 3 of the above-described embodiment, an RGB image acquiring section to acquire the RGB image and a depth image acquiring section to acquire the depth image may be integrally provided in one case, or may be respectively provided in separate cases.

### INDUSTRIAL APPLICABILITY

The present invention is suitably applied to a posture estimation system for estimating a posture of an object.

### DESCRIPTION OF REFERENCE NUMERALS

1 Posture estimation device
2 RGB-D camera (three-dimensional camera)
3 RGB-D camera (three-dimensional camera)
100 Posture estimation system

1. A posture estimation system for estimating a posture of an object, comprising:
a plurality of three-dimensional cameras taking images of the object from different angles;
an estimation section estimating, by using two-dimensional images respectively acquired by the plurality of three-dimensional cameras, a position of a predetermined section of the object on the two-dimensional images;
a determination section determining reliability of depth information on the position estimated by the estimation section based on a change over time of the depth information; and
a calculation section calculating the position of the predetermined section of the object in consideration of a determination result of the determination section.

2. The posture estimation system according to claim 1, wherein
the estimation section learns a feature of the predetermined section of the object on the two-dimensional images so as to track the predetermined section.

3. A posture estimation system for estimating a posture of an object, comprising:
at least three three-dimensional cameras taking images of the object from different angles;
a three-dimensional position calculation section calculating three-dimensional positions of a predetermined section of the object based on respective three-dimensional images acquired by the at least three three-dimensional cameras; and
a reliability evaluation section evaluating reliability of each of the three-dimensional positions based on at least three of the three-dimensional positions calculated by the three-dimensional position calculation section.

4. The posture estimation system according to claim 3, further comprising an estimation section estimating, by using respective two-dimensional images acquired by the at least three three-dimensional cameras, a position of the predetermined section of the object on the two-dimensional images, wherein
the estimation section learns a feature of the predetermined section of the object on the two-dimensional images so as to track the predetermined section, and furthermore re-learns the feature of the predetermined section on a two-dimensional image by a three-dimensional camera whose acquired three-dimensional position is estimated to have a low reliability by the reliability evaluation section out of the at least three three-dimensional cameras, so as to re-track the predetermined section.
